(19) United States
(12) Patent Application Publication
(10) Pub. No.: US 2012/0214929 A1
(43) Pub. Date: Aug. 23, 2012

(54) INJECTION MOLDED ARTICLE AND POLY(ARYLENE ETHER) COMPOSITION FOR USE THEREIN

(76) Inventors: James Ross Fishburn, Slingerlands, NY (US); Sho Sato, Tochigi-ken (JP)

(21) Appl. No.: 13/033,030

(22) Filed: Feb. 23, 2011

(51) Int. Cl. C08L 53/02; C08L 71/12

(52) U.S. Cl. 524/445; 525/92 D; 524/505

(57) ABSTRACT

Injection molded articles, such as automotive headlight bezels, are formed from a composition that includes specific amounts of a poly(arylene ether), a rubber-modified polystyrene, a hydrogenated block copolymer, and an aliphatic hydrocarbon resin. The injection molded articles are significantly lighter than corresponding articles prepared from both mineral filled polyester compositions and unfilled polyester compositions, so they contribute to fuel efficiency without sacrificing impact strength, heat resistance, gloss, and melt flow properties.

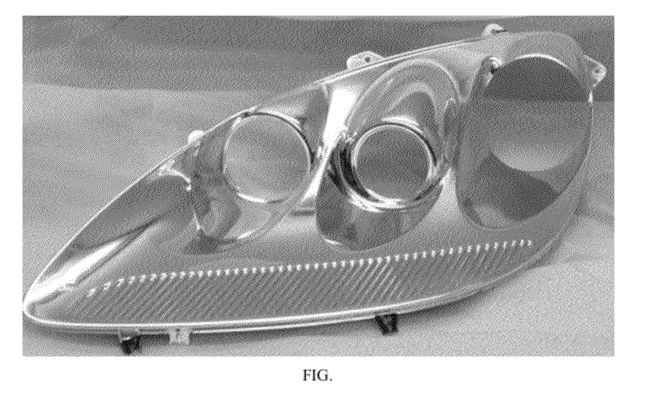

### BACKGROUND OF THE INVENTION

Poly(arylene ether) is a thermoplastic suitable for injection molding and known for its excellent water resistance, dimensional stability, and inherent flame retardancy. Other properties such as strength, stiffness, chemical resistance, and heat resistance can be tailored by blending it with various other thermoplastics in order to meet the requirements of a wide variety of consumer products, for example, plumbing fixtures, electrical boxes, insulation for wire and cable, and in particular for automotive parts.

There is an increasing focus on weight reduction for automotive parts in order to help improve fuel efficiency of cars. The lighter the car, the better the fuel efficiency, all else being equal. This applies to molded plastic parts as well as to metal parts. Automotive headlight housings or “bezels” are currently made from unfilled or filled polybutylene terephthalate (PBT) based or polycarbonate (PC) based compositions, which have specific gravities greater than 1.30. Moreover, some compositions, for example polycarbonate/poly(acrylonitrile-butadiene-styrene) blends, do not have a high enough heat resistance for use in automotive headlight bezels. Even for those compositions possessing an adequate balance of mechanical, thermal, and melt flow properties, their high specific gravity makes them undesirable for future use in cars where weight and fuel efficiency are of increasing importance.

In order to reduce the weight of automotive parts, and thereby increase fuel efficiency, there is a need for injection molding compositions having reduced specific gravity while still meeting or exceeding all of the stringent performance standards for automotive parts.

### BRIEF DESCRIPTION OF THE INVENTION

One embodiment is an injection molded article comprising a composition comprising about 76 to about 94 weight percent of a poly(arylene ether); about 2 to about 8 weight percent of a rubber-modified polystyrene comprising about 1 to about 30 weight percent, based on the weight of the rubber-modified polystyrene, of rubber particles having a volume average particle diameter of about 0.1 to about 2.0 micrometers; about 2 to about 8 weight percent of a hydrogenated block copolymer of an alkenyl aromatic compound and a conjugated diene, wherein the hydrogenated block copolymer has a poly(alkenyl aromatic) content of about 10 to about 45 weight percent, based on the weight of the hydrogenated block copolymer, and wherein the hydrogenated block copolymer has a weight average molecular weight of at least about 200,000 atomic mass units; and about 2 to about 8 weight percent of a hydrocarbon resin; wherein all weight percents are based on the total weight of the composition unless a different weight basis is specified.

Another embodiment is a composition comprising about 76 to about 94 weight percent of a poly(arylene ether); about 2 to about 8 weight percent of a rubber-modified polystyrene comprising about 1 to about 30 weight percent, based on the weight of the rubber-modified polystyrene, of rubber particles having a volume average particle diameter of about 0.1 to about 2.0 micrometers; about 2 to about 8 weight percent of hydrogenated block copolymer of an alkenyl aromatic compound and a conjugated diene, wherein the hydrogenated block copolymer has a poly(alkenyl aromatic) content of about 10 to about 45 weight percent, based on the weight of the hydrogenated block copolymer, and wherein the hydrogenated block copolymer has a weight average molecular weight of at least about 200,000 atomic mass units; and about 2 to about 8 weight percent of a hydrocarbon resin; wherein all weight percents are based on the total weight of the composition unless a different weight basis is specified.

These and other embodiments are described in further detail below.

### BRIEF DESCRIPTION OF THE FIGURE

The sole FIGURE is an image of an injection molded automotive headlight bezel that has been metallized.

### DETAILED DESCRIPTION OF THE INVENTION

The present inventors have determined that compositions exhibiting reduced specific gravity, in combination with a good balance of thermal and mechanical properties, can be obtained with the combination of specific amounts of poly(arylene ether), rubber-modified polystyrene, hydrogenated block copolymer, and hydrocarbon resin. Thus, an article, for example an automotive headlamp bezel, injection molded from this composition is lighter than an article molded from conventional compositions. The reduced weight of an article molded from the composition will result, for example, in increased fuel economy for a vehicle comprising articles molded from the composition. The composition also meets other performance standards for automotive parts, including impact strength, heat distortion temperature, and 60° gloss. The composition also exhibits a melt flow index suitable for injection molding of complex articles, for example automotive headlamp bezels.

As demonstrated in the working examples, the presence of high molecular weight hydrogenated block copolymer and hydrocarbon resin results in increased impact strength. The presence of hydrocarbon resin also results in increased gloss and suitable melt flow. Moreover, the average size and amount of rubber particles in the rubber-modified polystyrene, the gel content of the rubber-modified polystyrene, the molecular weight of the hydrogenated block copolymer, and the softening point of the hydrocarbon resin are important parameters for obtaining the desired combination of physical properties.

Thus, one embodiment is an injection molded article comprising: about 76 to about 94 weight percent of a poly(arylene ether); about 2 to about 8 weight percent of a rubber-modified polystyrene comprising about 1 to about 30 weight percent, based on the weight of the rubber-modified polystyrene, of rubber particles having a volume average particle diameter of about 0.1 to about 2.0 micrometers; about 2 to about 8 weight percent of a hydrogenated block copolymer of an alkenyl aromatic compound and a conjugated diene, wherein the hydrogenated block copolymer has a poly(alkenyl aromatic) content of about 10 to about 45 weight percent, based on the weight of the hydrogenated block copolymer, and wherein the hydrogenated block copolymer has a weight average molecular weight of at least 200,000 atomic mass units; and about 2 to about 8 weight percent of a hydrocarbon resin; wherein all weight percents are based on the total weight of the composition unless a different weight basis is specified.

Another embodiment is an injection molded article, wherein the injection molded article comprises a composition comprising: about 80 to about 90 weight percent of the poly(arylene ether); about 3 to about 6 weight percent of the rubber-modified polystyrene; about 3 to about 6 weight percent of the hydrogenated block copolymer; about 3 to about 6 weight percent of the hydrocarbon resin; and wherein the poly(arylene ether) is poly(2,6-dimethyl-1,4-phenylene ether) having an intrinsic viscosity of about 0.35 to about 0.50 deciliter per gram, measured at 25° C. in chloroform; wherein the rubber-modified polystyrene comprises about 10 to about 16 weight percent, based on the weight of the rubber-modified polystyrene, of rubber particles having a volume average particle diameter of about 0.4 to about 1 micrometers; wherein the rubber-modified polystyrene has a gel content of about 10 to about 16 weight percent, and a mineral oil content of less than about 0.5 weight percent; wherein the hydrogenated block copolymer is a polystyrene-poly(ethylene-butylene)-polystyrene triblock copolymer having a weight average molecular weight of about 240,000 to about 400,000 atomic mass units; and wherein the hydrocarbon resin has a softening point of about 120 to about 130° C., measured according to ASTM E28-99.

Another embodiment is a composition comprising: about 76 to about 94 weight percent of a poly(arylene ether); about 2 to about 8 weight percent of a rubber-modified polystyrene comprising about 1 to about 30 weight percent, based on the weight of the rubber-modified polystyrene, of rubber particles having a volume average particle diameter of about 0.1 to about 2.0 micrometers, as measured by transmission electron microscopy; about 2 to about 8 weight percent of hydrogenated block copolymer of an alkenyl aromatic compound and a conjugated diene, wherein the hydrogenated block copolymer has a poly(alkenyl aromatic) content of about 10 to 45 weight percent, based on the weight of the hydrogenated block copolymer, and wherein the hydrogenated block copolymer has a weight average molecular weight of at least 200,000 atomic mass units; and about 2 to about 8 weight percent of a hydrocarbon resin; wherein all weight percents are based on the total weight of the composition unless a different weight basis is specified.

Methods and apparatus for injection molding are known in the art, and a specific embodiment of injection molding conditions is described in the working examples below. In some embodiments, the molding method comprises using a melt temperature of about 280 to about 320° C., specifically about 290 to about 310° C., and more specifically about 295 to about 305° C. In this context, the term “melt temperature” refers to the temperature of the melt as it enters the mold. In some embodiments, the molding method comprises using a mold temperature of 60 to about 140° C., specifically about 70 to about 130° C., and more specifically about 80 to about 120° C.

The poly(arylene ether) used to form the composition comprises repeating structural units of the formula

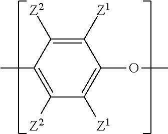

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

In some embodiments, the poly(arylene ether) has an intrinsic viscosity of about 0.25 to about 1 deciliter per gram measured at 25° C. in chloroform. Within this range, the poly(arylene ether) intrinsic viscosity can be about 0.3 to about 0.65 deciliter per gram, more specifically about 0.35 to about 0.5 deciliter per gram, even more specifically about 0.4 to about 0.5 deciliter per gram.

In some embodiments, the poly(arylene ether) is characterized by a weight average molecular weight and a peak molecular weight, wherein a ratio of the weight average molecular weight to the peak molecular weight is about 1.3:1 to about 4:1. Within this range, the ratio can be about 1.5:1 to about 3:1, specifically about 1.5:1 to about 2.5:1, more specifically about 1.6:1 to about 2.3:1, still more specifically 1.7:1 to about 2.1:1. The poly(arylene ether) molecular weight distribution is typically analyzed in the molecular weight range from 250 to 1,000,000 atomic mass units. As used herein, the term “peak molecular weight” is defined as the most commonly occurring molecular weight in the molecular weight distribution. In statistical terms, the peak molecular weight is the mode of the molecular weight distribution. In practical terms, when the molecular weight is determined by a chromatographic method such as gel permeation chromatography, the peak molecular weight is the poly(arylene ether) molecular weight of the highest point in a plot of molecular weight on the x-axis versus absorbance on the y-axis. A detailed procedure for determining a molecular weight distribution using gel permeation chromatography is presented in the working examples.

In some embodiments, the poly(arylene ether) is a poly(2,6-dimethyl-1,4-phenylene ether) prepared with a morpholine-containing catalyst, wherein a purified sample of poly(2,6-dimethyl-1,4-phenylene ether) prepared by dissolution of the poly(2,6-dimethyl-1,4-phenylene ether) in toluene, precipitation from methanol, reslurry, and isolation has a monomodal molecular weight distribution in the molecular weight range of 250 to 1,000,000 atomic mass units, and comprises less than or equal to 2.2 weight percent of poly(2,6-dimethyl-1,4-phenylene ether) having a molecular weight more than fifteen times the number average molecular weight of the entire purified sample. In some embodiments, the purified sample after separation into six equal poly(2,6-dimethyl-1,4-phenylene ether) weight fractions of decreasing molecular weight comprises a first, highest molecular weight fraction comprising at least 10 mole percent of poly(2,6-dimethyl-1,4-phenylene ether) comprising a terminal morpholine-substituted phenoxy group. The poly(2,6-dimethyl-1,4-phenylene ether) according to these embodiments is further described in U.S. Patent Application Publication No. US 2011/0003962 A1 of Carrillo et al.

In some embodiments, the poly(arylene ether) is essentially free of incorporated diphenoquinone residues. In the context, “essentially free” means that the fewer than 1 weight percent of poly(arylene ether) molecules comprise the residue of a diphenoquinone. As described in U.S. Pat. No. 3,306,874 to Hay, synthesis of poly(arylene ether) by oxidative polymerization of monohydric phenol yields not only the desired poly(arylene ether) but also a diphenoquinone as side product. For example, when the monohydric phenol is 2,6-dimethylphenol, 3,3′,5,5′-tetramethyldiphenoquinone is generated. Typically, the diphenoquinone is “reequilibrated” into the poly(arylene ether) (i.e., the diphenoquinone is incorporated into the poly(arylene ether) structure) by heating the polymerization reaction mixture to yield a poly(arylene ether) comprising terminal or internal diphenoquinone residues. For example, as shown in Scheme 1, when a poly(arylene ether) is prepared by oxidative polymerization of 2,6-dimethylphenol to yield poly(2,6-dimethyl-1,4-phenylene ether) and 3,3′,5,5′-tetramethyldiphenoquinone, reequilibration of the reaction mixture can produce a poly(arylene ether) with terminal and internal residues of incorporated diphenoquinone.

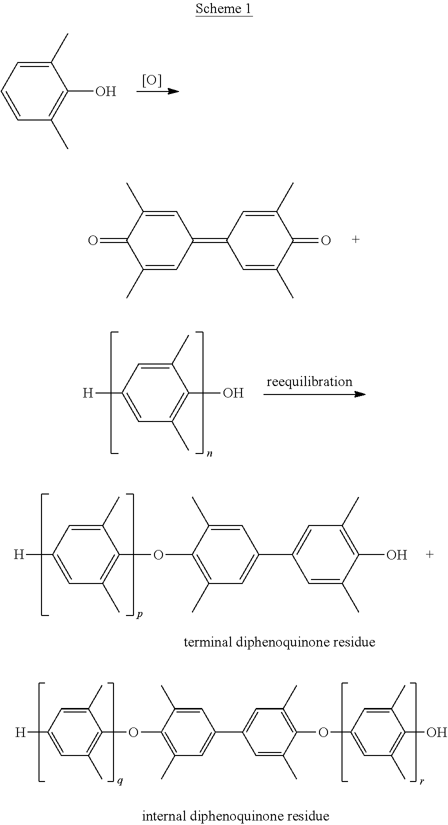

However, such reequilibration reduces the molecular weight of the poly(arylene ether) (e.g., p and q+r are less than n). Accordingly, when a higher molecular weight poly(arylene ether) is desired, it may be desirable to separate the diphenoquinone from the poly(arylene ether) rather than reequilibrating the diphenoquinone into the poly(arylene ether) chains. Such a separation can be achieved, for example, by precipitation of the poly(arylene ether) in a solvent or solvent mixture in which the poly(arylene ether) is insoluble and the diphenoquinone is soluble. For example, when a poly(arylene ether) is prepared by oxidative polymerization of 2,6-dimethylphenol in toluene to yield a toluene solution comprising poly(2,6-dimethyl-1,4-phenylene ether) and 3,3′,5,5′-tetramethyldiphenoquinone, a poly(2,6-dimethyl-1,4-phenylene ether) essentially free of diphenoquinone can be obtained by mixing 1 volume of the toluene solution with about 1 to about 4 volumes of methanol or a methanol/water mixture. Alternatively, the amount of diphenoquinone side-product generated during oxidative polymerization can be minimized (e.g., by initiating oxidative polymerization in the presence of less than 10 weight percent of the monohydric phenol and adding at least 95 weight percent of the monohydric phenol over the course of at least 50 minutes), and/or the reequilibration of the diphenoquinone into the poly(arylene ether) chain can be minimized (e.g., by isolating the poly(arylene ether) no more than 200 minutes after termination of oxidative polymerization). These approaches are described in International Patent Application Publication No. WO2009/104107 A1 of Delsman et al. In an alternative approach utilizing the temperature-dependent solubility of diphenoquinone in toluene, a toluene solution containing diphenoquinone and poly(arylene ether) can be adjusted to a temperature of about 25° C., at which diphenoquinone is poorly soluble but the poly(arylene ether) is soluble, and the insoluble diphenoquinone can be removed by solid-liquid separation (e.g., filtration).

In some embodiments, the poly(arylene ether) comprises 2,6-dimethyl-1,4-phenylene ether units, 2,3,6-trimethyl-1,4-phenylene ether units, or a combination thereof. In some embodiments, the poly(arylene ether) is a poly(2,6-dimethyl-1,4-phenylene ether). In some embodiments, the poly(arylene ether) comprises a poly(2,6-dimethyl-1,4-phenylene ether) having an intrinsic viscosity of about 0.35 to about 0.5 deciliter per gram, specifically about 0.35 to about 0.46 deciliter per gram, measured at 25° C. in chloroform.

The poly(arylene ether) can comprise molecules having aminoalkyl-containing end group(s), typically located in a position ortho to the hydroxy group. Also frequently present are tetramethyldiphenoquinone (TMDQ) end groups, typically obtained from 2,6-dimethylphenol-containing reaction mixtures in which tetramethyldiphenoquinone by-product is present. The poly(arylene ether) can be in the form of a homopolymer, a copolymer, a graft copolymer, an ionomer, or a block copolymer, as well as combinations comprising at least one of the foregoing.

The amount of poly(arylene ether) in the composition is about 76 to about 94 weight percent, based on the total weight of the composition. Within this range, the poly(arylene ether) amount can be about 78 to about 92 weight percent, specifically about 80 to about 90 weight percent, more specifically about 82 to about 88 weight percent, still more specifically about 83 to about 87 weight percent, and yet more specifically about 84 to about 86 weight percent.

In addition to the poly(arylene ether), the composition comprises a rubber-modified polystyrene. The rubber-modified polystyrene comprises polystyrene and a rubber. Rubber-modified polystyrenes are sometimes referred to as “high-impact polystyrenes” or “HIPS”. The rubber can be polybutadiene, ethylene-propylene rubber (EPM), ethylene-propylene-diene monomer rubber (EPDM), styrene-butadiene rubber (SBR), polyisoprene, or a combination thereof.

In some embodiments, the amount of polystyrene in the rubber-modified polystyrene is about 70 to about 99 weight percent, specifically about 75 to about 95 weight percent, more specifically about 80 to about 90 weight percent, and still more specifically about 85 to about 90 weight percent. The amount of rubber particles in the rubber-modified polystyrene is about 1 to about 30 weight percent, specifically about 5 to about 25 weight percent, more specifically about 10 to about 20 weight percent, and still more specifically about 10 to about 16 weight percent. In some embodiments, the rubber-modified polystyrene has an effective gel content of about 10 to about 40 weight percent, specifically about 15 to about 35 weight percent, more specifically about 20 to about 30 weight percent, and still more specifically about 24 to about 28 weight percent. In some embodiments, the rubber-modified polystyrene has a mineral oil content of less than about 2.0 weight percent, specifically less than about 1.5 weight percent, and still more specifically less than about 1.0 weight percent.

The rubber in the rubber-modified polystyrene is in the form of particles distributed throughout a polystyrene matrix. The rubber particles have a volume average particle diameter of about 0.1 to about 2.0 micrometers, specifically about 0.2 to about 1.5 micrometers, and more specifically about 0.4 to about 1.0 micrometer.

The volume average particle diameter of the rubber particles is obtained by measuring individual particle diameters (=(longer diameter+shorter diameter)/2) of about 500 to about 700 rubber particles by transmission electron microscopy on ultra-thin slices of the rubber-modified polystyrene. The volume average particle diameter is then calculated by dividing the fourth moment of the particle size distribution by the third moment of the particle size distribution as follows:

Volume average particle diameter=Σnᵢ·Dᵢ⁴/Σnᵢ·Dᵢ³

wherein nᵢ represents the number of rubber particles having a particle diameter of Dᵢ. Alternatively, the volume average particle diameter of the rubber particles can be measured using a laser diffraction particle analyzer, for example and LS-230 particle analyzer, available from Beckman Coulter, Inc. U.S. Pat. Nos. 5,506,304 to Otsuzuki et al., 5,550,186 to Cantrill et al., and 7,199,187 to Miyakawa et al. provide methods for measuring volume average particle diameter of rubber particles in rubber-modified polystyrene.

Processes for making rubber-modified polystyrenes having a volume average particle diameter of about 0.1 to about 2.0 micrometers are provided, for example, in U.S. Pat. Nos. 5,506,304 to Otsuzuki et al. and 5,210,132 to Matsubara et al. Suitable rubber-modified polystyrenes are also commercially available as, for example, TOYO XL1 from Toyo Styrene K.K.

The amount of rubber-modified polystyrene in the composition is about 2 to about 8 weight percent, based on the total weight of the composition. Within this range, the rubber-modified polystyrene amount can be about 2 to about 7 weight percent, and specifically about 3 to about 6 weight percent.

In addition to the poly(arylene ether) and the rubber-modified polystyrene, the composition comprises a hydrogenated block copolymer of an alkenyl aromatic compound and a conjugated diene. For brevity, this component is referred to as the “hydrogenated block copolymer”, or “HBC”. The hydrogenated block copolymer may comprise about 10 to about 90 weight percent of poly(alkenyl aromatic) content and about 90 to about 10 weight percent of hydrogenated poly(conjugated diene) content, based on the weight of the hydrogenated block copolymer. In some embodiments, the poly(alkenyl aromatic) content is about 10 to about 45 weight percent, specifically about 20 to about 40 weight percent, more specifically about 25 to about 35 weight percent, and still more specifically about 30 to about 35 weight percent. In other embodiments, the poly(alkenyl aromatic) content is about 45 weight percent to about 90 weight percent, and specifically about 45 to about 80 weight percent. The hydrogenated block copolymer can have a weight average molecular weight of about 40,000 to about 400,000 atomic mass units. The number average molecular weight and the weight average molecular weight may be determined by gel permeation chromatography and based on comparison to polystyrene standards. In some embodiments, the hydrogenated block copolymer has a weight average molecular weight of at least about 200,000 atomic mass units, and specifically at least about 220,000 atomic mass units.

The alkenyl aromatic monomer used to prepare the hydrogenated block copolymer can have the structure

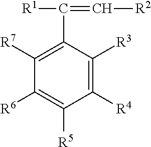

wherein R¹ and R² each independently represent a hydrogen atom, a C₁-C₈ alkyl group, or a C₂-C₈ alkenyl group; R³ and R⁷ each independently represent a hydrogen atom, a C₁-C₈ alkyl group, a chlorine atom, or a bromine atom; and R⁴, R⁵, and R⁶ each independently represent a hydrogen atom, a C₁-C₈ alkyl group, or a C₂-C₈ alkenyl group, or R⁴ and R⁵ are taken together with the central aromatic ring to form a naphthyl group, or R⁵ and R⁶ are taken together with the central aromatic ring to form a naphthyl group. Specific alkenyl aromatic monomers include, for example, styrene, chlorostyrenes such as p-chlorostyrene, and methylstyrenes such as alpha-methylstyrene and p-methylstyrene. In some embodiments, the alkenyl aromatic monomer is styrene.

The conjugated diene used to prepare the hydrogenated block copolymer can be a C₄-C₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In some embodiments, the conjugated diene is 1,3-butadiene, 2-methyl-1,3-butadiene, or a combination thereof. In some embodiments, the conjugated diene consists of 1,3-butadiene.

The hydrogenated block copolymer is a copolymer comprising (A) at least one block derived from an alkenyl aromatic compound and (B) at least one block derived from a conjugated diene, in which the aliphatic unsaturated group content in the block (B) is at least partially reduced by hydrogenation. In some embodiments, the aliphatic unsaturation in the (B) block is reduced by at least about 50 percent, specifically at least about 70 percent. The arrangement of blocks (A) and (B) includes a linear structure, a grafted structure, and a radial teleblock structure with or without a branched chain. Linear block copolymers include tapered linear structures and non-tapered linear structures. In some embodiments, the hydrogenated block copolymer has a tapered linear structure. In some embodiments, the hydrogenated block copolymer has a non-tapered linear structure. In some embodiments, the hydrogenated block copolymer comprises a B block that comprises random incorporation of alkenyl aromatic monomer. Linear block copolymer structures include diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of A and B, wherein the molecular weight of each A block may be the same as or different from that of other A blocks, and the molecular weight of each B block may be the same as or different from that of other B blocks. In some embodiments, the hydrogenated block copolymer is a diblock copolymer, a triblock copolymer, or a combination thereof.

In some embodiments, the hydrogenated block copolymer excludes the residue of monomers other than the alkenyl aromatic compound and the conjugated diene.

In some embodiments, the hydrogenated block copolymer consists of blocks derived from the alkenyl aromatic compound and the conjugated diene. It does not comprise grafts formed from these or any other monomers. It also consists of carbon and hydrogen atoms and therefore excludes heteroatoms.

In some embodiments, the hydrogenated block copolymer includes the residue of one or more acid functionalizing agents, such as maleic anhydride.

In some embodiments, the hydrogenated block copolymer comprises a polystyrene-poly(ethylene-butylene)-polystyrene triblock copolymer.

In some embodiments, the hydrogenated block copolymer comprises a polystyrene-poly(ethylene-butylene)-polystyrene triblock copolymer having a weight average molecular weight of about 200,000 to about 400,000 atomic mass units, specifically about 240,000 to about 350,000 atomic mass units, more specifically about 240,000 to about 300,000 atomic mass units.

Methods for preparing hydrogenated block copolymers are known in the art and many hydrogenated block copolymers are commercially available. Illustrative commercially available hydrogenated block copolymers include the polystyrene-poly(ethylene-propylene) diblock copolymers available from Kraton Polymers as KRATON G1701 and G1702; the polystyrene-poly(ethylene-butylene)-polystyrene triblock copolymers available from Kraton Polymers as KRATON G1641, G1650, G1651, G1654, G1657, G1726, G4609, G4610, GRP-6598, RP-6924, MD-6932M, MD-6933, and MD-6939; the polystyrene-poly(ethylene-butylene-styrene)-polystyrene (S-EB/S-S) triblock copolymers available from Kraton Polymers as KRATON RP-6935 and RP-6936, the polystyrene-poly(ethylene-propylene)-polystyrene triblock copolymers available from Kraton Polymers as KRATON G1730; the maleic anhydride-grafted polystyrene-poly(ethylene-butylene)-polystyrene triblock copolymers available from Kraton Polymers as KRATON G1901, G1924, and MD-6684; the maleic anhydride-grafted polystyrene-poly(ethylene-butylene-styrene)-polystyrene triblock copolymer available from Kraton Polymers as KRATON MD-6670; the polystyrene-poly(ethylene-butylene)-polystyrene triblock copolymer comprising 67 weight percent polystyrene available from Asahi Kasei Elastomer as TUFTEC H1043; the polystyrene-poly(ethylene-butylene)-polystyrene triblock copolymer comprising 42 weight percent polystyrene available from Asahi Kasei Elastomer as TUFTEC H1051; the polystyrene-poly(butadiene-butylene)-polystyrene triblock copolymers available from Asahi Kasei Elastomer as TUFTEC P1000 and P2000; the polystyrene-polybutadiene-poly(styrene-butadiene)-polystyrene block copolymer available from Asahi Kasei Elastomer as S.O.E.-SS L601; the hydrogenated radial block copolymers available from Chevron Phillips Chemical Company as K-Resin KK38, KR01, KR03, and KR05; the polystyrene-poly(ethylene-butylene)-polystyrene triblock copolymer comprising 60 weight polystyrene available from Kuraray as SEPTON 58104; the polystyrene-poly(ethylene-ethylene/propylene)-polystyrene triblock copolymers available from Kuraray as SEPTON S4044, S4055, S4077, and S4099; and the polystyrene-poly(ethylene-propylene)-polystyrene triblock copolymer comprising 65 weight percent polystyrene available from Kuraray as SEPTON S2104. Mixtures of two or more hydrogenated block copolymers can be used.

The composition comprises the hydrogenated block copolymer in an amount of about 2 to about 8 weight percent, specifically about 2 to about 7 weight percent, and more specifically about 3 to about 6 weight percent, based on the total weight of the composition.

In addition to the poly(arylene ether), the rubber-modified polystyrene, and the hydrogenated block copolymer, the composition comprises a hydrocarbon resin. Examples of hydrocarbon resins are aliphatic hydrocarbon resins, hydrogenated aliphatic hydrocarbon resins, aliphatic/aromatic hydrocarbon resins, hydrogenated aliphatic/aromatic hydrocarbon resins, cycloaliphatic hydrocarbon resins, hydrogenated cycloaliphatic resins, cycloaliphatic/aromatic hydrocarbon resins, hydrogenated cycloaliphatic/aromatic hydrocarbon resins, hydrogenated aromatic hydrocarbon resins, polyterpene resins, terpene-phenol resins, rosins and rosin esters, hydrogenated rosins and rosin esters, and mixtures of two or more thereof. As used herein, “hydrogenated”, when referring to the hydrocarbon resin, includes fully, substantially, and partially hydrogenated resins. Suitable aromatic resins include aromatic modified aliphatic resins, aromatic modified cycloaliphatic resin, and hydrogenated aromatic hydrocarbon resins having an aromatic content of about 1 to about 30 weight percent. Any of the above resins may be grafted with an unsaturated ester or anhydride using methods known in the art. Such grafting can provide enhanced properties to the resin. In one embodiment, the hydrocarbon resin is a hydrogenated aromatic hydrocarbon resin.

Suitable hydrocarbon resins are commercially available and include, for example, EMPR 100, 101, 102, 103, 104, 105, 106, 107, 108, 109, 110, 116, 117, and 118 resins, and OPPERA resins, available from ExxonMobil Chemical Company; ARKON P140, P125, P115, M115, and M135, and SUPER ESTER rosin esters available from Arakawa Chemical Company of Japan; SYLVARES polyterpene resins, styrenated terpene resins and terpene phenolic resins available from Arizona Chemical Company; SYLVATAC and SYLVALITE rosin esters available from Arizona Chemical Company; NORSOLENE aliphatic aromatic resins available from Cray Valley; DERTOPHENE terpene phenolic resins and DERCOLYTE polyterpene resins available from DRT Chemical Company; EASTOTAC resins, PICCOTAC resins, REGALITE and REGALREZ hydrogenated cycloaliphatic/aromatic resins, and PICCOLYTE and PERMALYN polyterpene resins, rosins, and rosin esters available from Eastman Chemical Company; WINGTACK resins available from Goodyear Chemical Company; coumarone/indene resins available from Neville Chemical Company; QUINTONE acid modified C5 resins, C5/C9 resins, and acid-modified C5/C9 resins available from Nippon Zeon; and CLEARON hydrogenated terpene resins available from Yasuhara.

In some embodiments, the hydrocarbon resins have softening points of about 80 to about 180° C., specifically about 100 to about 170° C., more specifically about 110 to about 150° C., and still more specifically about 120 to about 130° C. Softening point is measured as a ring and ball softening point according to ASTM E28-99. A specific hydrocarbon resin is ARKON P125, which has a softening point of about 125° C.

The composition comprises the hydrocarbon resin in an amount of about 2 to about 8 weight percent, specifically about 2 to about 7 weight percent, and more specifically about 3 to about 6 weight percent, based on the total weight of the composition.

The composition can, optionally, further comprise a polystyrene. In some embodiments, the polystyrene is an atactic polystyrene. In other embodiments, the polystyrene is a syndiotactic polystyrene. When present, the amount of polystyrene is about 0.5 to about 6 weight percent, and specifically about 1 to about 5 weight percent, based on the total weight of the composition. When polystyrene is present, the total weight of polystyrene and rubber-modified polystyrene is about 2 to about 8 weight percent, specifically about 2 to about 7 weight percent, and more specifically about 3 to about 6 weight percent.

The composition can, optionally, further comprise one or more additives such as, for example, stabilizers, mold release agents, processing aids, drip retardants, nucleating agents, UV blockers, dyes, pigments, antioxidants, anti-static agents, mineral oil, metal deactivators, antiblocking agents, nanoclays, and electrically conductive agents. When present, the collective amount of all additives can be about 0.5 to about 5 weight percent, specifically about 1 to about 4 weight percent, and more specifically about 1.5 to about 3 weight percent, based on the total weight of the composition.

In some embodiments, the composition comprises less than about 1 weight percent, specifically less than about 0.5 weight percent, and more specifically less than about 0.1 weight percent, of a polymer selected from the group consisting of polyesters, polyamides, unhydrogenated block copolymers of an alkenyl aromatic compound and a conjugated diene, EPDM rubbers, thermoplastic polyolefins, and thermoplastic vulcanizates. In some embodiments, the composition excludes polyamides, polyesters, unhydrogenated block copolymers of an alkenyl aromatic compound and a conjugated diene, EPDM rubbers, thermoplastic polyolefins, and thermoplastic vulcanizates.

EPDM rubbers are terpolymers, or interpolymers, of ethylene, an alpha-olefin and a diene. Specific EPDM rubbers comprise terpolymers, or interpolymers, of ethylene, an alpha-olefin containing from 3 to 16 carbon atoms, and a non-conjugated cyclic or open-chain diene having from 5 to 20 carbon atoms.

The alpha-olefins used in making the EPDM rubber are alpha-olefins having the formula CH₂═CHR, in which R can be saturated alkyl, for example, methyl, ethyl, n-propyl, isopropyl, and so forth. Specific EPDM rubbers comprise polypropylene as the alpha-monoolefin.

Examples of suitable dienes which may be used are: 1,4-hexadiene; 1,6-octadiene; 2-methyl-1,5-hexadiene; 6-methyl-L5-heptadiene; 7-methyl-1,6-octadiene; 11-ethyl-1,11-tridecadiene; 9-ethyl-1,9-undecadiene; isoprene; 1,4-pentadiene; 1,3-pentadiene; 1,4,9-decatriene; myrcene; 1-phenyl-1,3-butadiene; p-diallylbenzene; p-bromoallylbenzene; vinyl-1-cyclohexene; 1,3,5-trivinylcyclohexane; trans-1,2-divinylcyclobutane; 1,5-cycloocta-diene; 1,3,5-cycloheptatriene; 1,5,9-cyclodecatriene; 1,4-cycloheptadiene; cyclopentadiene; 2,2′-dicyclopentenyl; 1,4-bis(cyclopenten-2-yl)butane; 4,7,8,9-tetrahydroindene; 6-methyl-4,7,8,9-tetrahydroindene; bicyclo(3,3,0)-octadiene-2,6-dicyclopentadiene; 2-methyl-2,5-norbornadiene; 5-methylene-2-norbornene; 5-ethylidene-2-norbornene; 5-isopropylidene-2-norbornene; 5-isopropenyl-2-norbornene; and the like

Methods for making the EPDM rubbers are known to those skilled in the art. They may be prepared by the polymerization reaction of a mixture of the monomers in a material solvent at an elevated temperature, in the presence of a Ziegler catalyst, followed by deactivation of the catalyst by the introduction of a lower alcohol. The disclosures in U.S. Pat. Nos. 3,000,866 to Tarney, 3,000,867 to Fisher, and 2,933,480 to Gresham et al. provide methods of preparation.

The EPDM rubber will contain about 10 to about 90 mole percent of ethylene, about 10 to about 90 mole percent of alpha-olefin, and about 0.1 to about 15 mole percent of diene. Specific examples of EPDM rubbers are rubbery interpolymers of ethylene, propylene and 5-ethylidene-2-norbornene; and of ethylene, propylene and dicyclopentadiene.

“Thermoplastic polyolefin”, as used herein, refers to thermoplastic crystalline and semi-crystalline polyolefin homopolymers and copolymers or combinations thereof. Specific examples of thermoplastic polyolefins are homopolymers of ethylene or propylene, copolymers of ethylene and propylene, copolymers of ethylene and an alpha-olefin with 4-12 carbon atoms, and copolymers of propylene and an alpha-olefin with 4-12 carbon atoms.

“Thermoplastic vulcanizate”, as used herein, refers to a blend comprising a thermoplastic polyolefin and a dynamically partially vulcanized rubber. Thermoplastic vulcanizates and their preparation are described, for example, in S. Abdou-Sabet, R. C. Puydak, and C. P. Rader, Rubber Chemistry and Technology, Vol. 69, pp. 476-493, 1996. Examples of suitable thermoplastic polyolefins used in the thermoplastic vulcanizate are thermoplastic crystalline and semi-crystalline polyolefin homopolymers and copolymers, or combinations thereof. Specific examples of thermoplastic polyolefins are homopolymers of ethylene or propylene, copolymers of ethylene and propylene, copolymers of ethylene and an alpha-olefin with 4-12 carbon atoms, and copolymers of propylene and an alpha-olefin with 4-12 carbon atoms. It is important that the ethylene or propylene content in the copolymers is sufficiently high that the copolymer is semi-crystalline. This is usually achieved at an ethylene or propylene content of about 70 mole percent or more. Specifically, the thermoplastic polyolefin is polypropylene.

Examples of rubbers that can be used in the thermoplastic vulcanizate are rubbers that are suitable for dynamic vulcanization. Examples of such rubbers are ethylene-propylene copolymers (EPM), ethylene-propylene-diene terpolymers, (EPDM), styrene butadiene rubber, nitrile butadiene rubber, isobutene-isoprene rubber, styrene-(ethylene-styrene)-butadiene block copolymers, butyl rubber, isobutylene-p-methylstyrene copolymers, brominated isobutylene-p-methylstyrene copolymers, natural rubber, and blends of these. Specifically, the rubber is EPDM or EPM. Most specifically, the rubber is EPDM. The EPDM preferably comprises about 50 to about 70 parts by weight ethylene monomer units, about 30 to about 48 parts by weight monomer units originating from an alpha-olefin, and about 2 to about 12 parts by weight monomer units originating from a non-conjugated diene. A specific alpha-olefin is propylene. Preferred non-conjugated dienes include dicyclopentadiene (DCPD), 5-ethylidene-2-norbornene (ENB), and vinylnorbornene (VNB).

The dynamic vulcanization of the rubber is carried out in the presence of a suitable vulcanization agent such as, for instance, sulfur, sulfurous compounds, metal oxides, maleimides, phenol resins, or peroxides. These vulcanization agents are known in the art and are described, for example, in U.S. Pat. No. 5,100,947 to Puydak et al. It is also possible to use a siloxane compound as a vulcanization agent. Examples include hydrosilanes and vinylalkoxysilanes. The degree of vulcanization can be expressed in terms of gel content. Determination of gel content is described in U.S. Pat. No. 5,100,947 to Puydak et al. The rubber in the thermoplastic vulcanizate is at least partly vulcanized and may have a gel content of about 60 to about 100%. Specifically, the rubber has a gel content of about 80 to about 100%. More specifically, the rubber is fully vulcanized and has a gel content in excess of about 95%.

Thermoplastic vulcanizates are commercially available and may be prepared by published methods. Exemplary thermoplastic vulcanizates include various grades of SANTOPRENE available from Monsanto, Kelprox and SARLINK available from DSM, and TREFSIN available from ExxonMobil.

In some embodiments, the composition comprises less than about 1 weight percent, specifically less than about 0.5 weight percent, and more specifically less than about 0.1 weight percent, of any polymer other than the poly(arylene ether), the rubber-modified polystyrene, the hydrogenated block copolymer, and the hydrocarbon resin. In some embodiments, the composition excludes any polymer other than the poly(arylene ether), the rubber-modified polystyrene, the hydrogenated block copolymer, and the hydrocarbon resin.

In some embodiments, the composition comprises less than about 1 weight percent, specifically less than about 0.5 weight percent, and more specifically less than about 0.1 weight percent, of a filler. In some embodiments, the composition excludes filler. The term “filler” includes particulate fillers (e.g., talc), fibrous fillers (e.g., glass fibers), and electrically conductive fillers (e.g., conductive carbon black, carbon nanotubes). It will be understood that the limitations on electrically conductive fillers do not apply to pigments, such as carbon black, which have low electrical conductivity and are used primarily for coloration.

In some embodiments, the composition consists essentially of the poly(arylene ether), the rubber-modified polystyrene, the hydrogenated block copolymer, the aliphatic hydrocarbon resin, and optionally, about 0.5 to about 5 weight percent, specifically about 1 to about 4 weight percent, and more specifically about 1.5 to about 3 weight percent, based on the total weight of the composition, of one or more additives selected from the group consisting of fillers, stabilizers, mold release agents, processing aids, drip retardants, nucleating agents, UV blockers, dyes, pigments, antioxidants, anti-static agents, mineral oil, metal deactivators, antiblocking agents, nanoclays, and electrically conductive agents. In this context, “consisting essentially of” excludes any unrecited component in an amount that would significantly increase specific gravity, decrease Izod notched impact strength, decrease heat deflection temperature, decrease 60° gloss, or decrease melt flow index.

In a specific embodiment, the composition comprises about 80 to about 90 weight percent of the poly(arylene ether); about 3 to about 6 weight percent of the rubber-modified polystyrene; about 3 to about 6 weight percent of the hydrogenated block copolymer; and about 3 to about 6 weight percent of the hydrocarbon resin; wherein the poly(arylene ether) is poly(2,6-dimethyl-1,4-phenylene ether) having an intrinsic viscosity of about 0.35 to about 0.50 deciliter per gram, measured at 25° C. in chloroform; wherein the rubber-modified polystyrene comprises about 10 to about 16 weight percent, based on the weight of the rubber-modified polystyrene, of rubber particles having a volume average particle diameter of about 0.4 to about 1 micrometers; wherein the rubber-modified polystyrene has a gel content of about 10 to about 16 weight percent, and a mineral oil content of less than about 1.5 weight percent; wherein the hydrogenated block copolymer is a polystyrene-poly(ethylene-butylene)-polystyrene triblock copolymer having a weight average molecular weight of about 240,000 to about 400,000 atomic mass units; and wherein the hydrocarbon resin has a softening point of about 120 to about 130° C., measured according to ASTM E28-99.

In addition to having a reduced specific gravity, the composition can exhibit a desirable balance of physical properties, including Izod notched impact strength, heat deflection temperature, 60° gloss, and melt flow index. For example, in some embodiments, the composition has a specific gravity of less than or equal to about 1.3 at 23° C., measured according to ASTM D792-08. The specific gravity can be about 1 to about 1.3, specifically about 1 to about 1.2, and more specifically about 1 to about 1.1. Notched Izod impact strength is a measure of the ductility of the composition. In some embodiments the composition exhibits a notched Izod impact strength of at least about 50 joules per meter, measured at 23° C. according to ASTM D256-10. The notched Izod impact strength can be about 50 to about 150 joules per meter, specifically about 60 to about 120, and more specifically, about 70 to about 110 joules per meter. Heat deflection temperature is a measure of the heat-resistance of the composition. In some embodiments the composition can exhibit a heat deflection temperature of at least about 160° C., measured according to ASTM D648-07, using Method B and a sample having dimensions 80 millimeters×10 millimeters×4 millimeters. The heat deflection temperature can be about 160 to about 180° C., and specifically about 165 to about 170° C. Gloss is a measure of the surface reflectance of a composition. In some embodiments the composition exhibits a 60° gloss of at least about 85 measured according to ASTM D523-08 on an article molded at a mold temperature of 80° C. The 60° gloss can be about 85 to about 95, and specifically about 90 to about 95. In some embodiments, the composition exhibits a melt flow index of at least 5 grams per 10 minutes, measured at 300° C. and under a 5 kilogram load according to ASTM D1238-10, Procedure B. The melt flow index can be about 5 to about 30 grams per 10 minutes, specifically about 5 to about 20 grams per 10 minutes, more specifically about 5 to about 10 grams per 10 minutes, and still more specifically about 5 to about 8 grams per 10 minutes. The composition can exhibit combinations of two or more of any of the above-described property values, a combination of three or more of any of the above-described property values, a combination of four or more of any of the above-described property values, or a combination of all five of the above-described property values.

The composition can be prepared by melt-blending or melt-kneading the individual components together. The blending or kneading can be done using common equipment such as ribbon blenders, Henschel mixers, Banbury mixers, drum tumblers, single screw extruders, twin-screw extruders, multi-screw extruders, co-kneaders, and the like.

Articles can be formed from the composition by shaping, extruding, or molding. In one embodiment, the article is formed by molding. Various known molding methods can be used, for example injection molding, injection compression molding, gas assist injection molding, rotary molding, compression molding, and the like.

In one embodiment, the article is formed by injection molding. In injection molding, the composition formed by blending or kneading, and in the form of pellets, is fed by an auger, from a hopper into a heated injection barrel. The injection barrel comprises a screw for feeding the composition into a mold, and external heaters. Once in the injection barrel, the composition is heated externally by the injection barrel so that the composition softens and melts to form a molten composition, or melt. The composition is further heated by the shearing force of the screw moving the composition forward. In one embodiment the target melt temperature is about 200 to about 400° C., specifically about 250 to about 350° C., and more specifically about 280 to about 320° C.

The amount of the molten composition sufficient to completely fill the mold is called a load, or shot. The shot is forced under pressure from the injection screw into a heated mold, where it ideally fills all the voids in the open volume of the mold. The composition is then cured sufficiently to be released from the mold as a firm piece. In one embodiment the mold temperature is about 50 to about 200° C., specifically about 50 to about 150° C., and more specifically about 50 to about 140° C. In one embodiment, the article is formed by compression injection molding. Compression injection molding is the same as injection molding, except that further compression is added to the composition while it resides in the mold. The disclosure in U.S. Pat. No. 5,916,496 to Weber provides a description of injection molding and compression injection molding.

In one embodiment, the article is metallized. For example, vacuum metallization can be used. Vacuum metallization includes both vacuum deposition and vacuum sputtering processes. Examples of metals used for vacuum metallization are chrome, aluminum, nickel, and the like. In one embodiment, the article is metallized by aluminum vapor deposition. In one embodiment, a base coat is applied to the surface of the article prior to metallization. The base coat serves to smooth out any surface roughness so that a high gloss metal surface is obtained. The surface of the article can be cleaned and degreased prior to application of the base coat or vacuum metallization in order to increase adhesion. U.S. Patent Publication Nos. 2008/0132630 to Konduri and 2007/0117897 to Onda et al. provide disclosures of vacuum metallization and the use of base coats in lighting articles formed from thermoplastic compositions.

All of the compositional variations described above apply to an injection molded article comprising the composition as well as the composition itself. A wide variety of articles can be manufactured using the composition. In one embodiment, the article is a component for a lighting article, including automotive headlights, headlight bezels, headlight extensions, and headlight reflectors. The articles can also be used for indoor illumination and for vehicle interior illumination. The automotive headlight bezel can be an extension reflector or sub reflector. In one embodiment the article is an automotive headlight bezel. An image of an exemplary headlight reflector is provided in the FIGURE.

The invention includes at least the following embodiments.

### Embodiment 1

An injection molded article comprising a composition comprising: about 76 to about 94 weight percent of a poly(arylene ether); about 2 to about 8 weight percent of a rubber-modified polystyrene comprising about 1 to about 30 weight percent, based on the weight of the rubber-modified polystyrene, of rubber particles having a volume average particle diameter of about 0.1 to about 2.0 micrometers; about 2 to about 8 weight percent of a hydrogenated block copolymer of an alkenyl aromatic compound and a conjugated diene, wherein the hydrogenated block copolymer has a poly(alkenyl aromatic) content of about 10 to about 45 weight percent, based on the weight of the hydrogenated block copolymer, and wherein the hydrogenated block copolymer has a weight average molecular weight of at least about 200,000 atomic mass units; and about 2 to about 8 weight percent of a hydrocarbon resin; wherein all weight percents are based on the total weight of the composition unless a different weight basis is specified.

### Embodiment 2

The injection molded article of embodiment 1, wherein the poly(arylene ether) is poly(2,6-dimethyl-1,4-phenylene ether) having an intrinsic viscosity of about 0.20 to about 0.60 deciliters per gram, measured at 25° C. in chloroform.

### Embodiment 3

The injection molded article of embodiment 1 or 2, wherein the rubber-modified polystyrene has a gel content of about 10 to about 40 weight percent, and a mineral oil content of less than about 2 weight percent.

### Embodiment 4

The injection molded article of embodiment 3, wherein the rubber-modified polystyrene comprises about 10 to about 16 weight percent, based on the weight of the rubber-modified polystyrene, of rubber particles having a volume average particle diameter of about 0.4 to about 1 micrometers; and wherein the rubber-modified polystyrene has a gel content of about 20 to about 30 weight percent, and a mineral oil content of less than about 1.5 weight percent.

### Embodiment 5

The injection molded article of any of embodiments 1-4, wherein the hydrogenated block copolymer is a linear block copolymer.

### Embodiment 6

The injection molded article of any of embodiments 1-5, wherein the hydrogenated block copolymer excludes the residue of monomers other than the alkenyl aromatic compound and the conjugated diene.

### Embodiment 7

The injection molded article of any of embodiments 1-6, wherein the alkenyl aromatic compound is styrene and the conjugated diene is butadiene.

### Embodiment 8

The injection molded article of any of embodiments 1-7, wherein the hydrogenated block copolymer comprises a polystyrene-poly(ethylene-butylene)-polystyrene triblock copolymer and less than about 20 weight percent, based on the total weight of the hydrogenated block copolymer, of polystyrene-poly(ethylene-butylene) diblock copolymer.

### Embodiment 9

The injection molded article of embodiment 8, wherein the polystyrene-poly(ethylene-butylene)-polystyrene triblock copolymer is substantially free of polystyrene-poly(ethylene-butylene) diblock copolymer.

### Embodiment 10

The injection molded article of any of embodiments 1-9, wherein the hydrocarbon resin has a softening point of about 80 to about 180° C., measured according to ASTM E28-99.

### Embodiment 11

The injection molded article of any of embodiments 1-10, wherein the thermoplastic composition further comprises about 0.5 to about 6 weight percent polystyrene, provided that the total weight of polystyrene and the rubber-modified polystyrene is about 2 to about 8 weight percent, based on the total weight of the composition.

### Embodiment 12

The injection molded article of any of embodiments 1-11, wherein the composition further comprises about 0.5 to about 5 weight percent collectively, based on the total weight of the composition, of one or more additives selected from the group consisting of stabilizers, mold release agents, processing aids, drip retardants, nucleating agents, UV blockers, dyes, pigments, antioxidants, anti-static agents, mineral oil, metal deactivators, antiblocking agents, nanoclays, and electrically conductive agents.

### Embodiment 13

The injection molded article of any of embodiments 1-12, wherein unhydrogenated block copolymers of an alkenyl aromatic compound and a conjugated diene, polyamides, polyesters, EPDM rubbers, thermoplastic polyolefins, and thermoplastic vulcanizates are all absent from the composition.

### Embodiment 14

The injection molded article of any of embodiments 1-13, wherein the composition comprises less than about 1 weight percent of any polymer other than the poly(arylene ether), the rubber-modified polystyrene, the hydrogenated block copolymer, and the hydrocarbon resin.

### Embodiment 15

The injection molded article of any of embodiments 1-14, wherein the composition comprises less than about 1 weight percent of a filler.

### Embodiment 16

The injection molded article of any of embodiments 1-10 and 12-15, wherein the composition consists essentially of the poly(arylene ether), the rubber-modified polystyrene, the hydrogenated block copolymer, the aliphatic hydrocarbon resin, and optionally, about 0.5 to about 5 weight percent collectively, based on the total weight of the composition, of one or more additives selected from the group consisting of fillers, stabilizers, mold release agents, processing aids, drip retardants, nucleating agents, UV blockers, dyes, pigments, antioxidants, anti-static agents, mineral oil, metal deactivators, antiblocking agents, nanoclays, and electrically conductive agents.

### Embodiment 17

The injection molded article of embodiment 1, wherein the composition comprises about 80 to about 90 weight percent of the poly(arylene ether); about 3 to about 6 weight percent of the rubber-modified polystyrene; about 3 to about 6 weight percent of the hydrogenated block copolymer; and about 3 to about 6 weight percent of the hydrocarbon resin; wherein the poly(arylene ether) is poly(2,6-dimethyl-1,4-phenylene ether) having an intrinsic viscosity of about 0.35 to about 0.50 deciliter per gram, measured at 25° C. in chloroform; wherein the rubber-modified polystyrene comprises about 10 to about 16 weight percent, based on the weight of the rubber-modified polystyrene, of rubber particles having a volume average particle diameter of about 0.4 to about 1 micrometers; wherein the rubber-modified polystyrene has a gel content of about 10 to about 16 weight percent, and a mineral oil content of less than about 1.5 weight percent; wherein the hydrogenated block copolymer is a polystyrene-poly(ethylene-butylene)-polystyrene triblock copolymer having a weight average molecular weight of about 240,000 to about 400,000 atomic mass units; and wherein the hydrocarbon resin has a softening point of about 120 to about 130° C., measured according to ASTM E28-99.

### Embodiment 18

The injection molded article of embodiment 17, wherein the composition exhibits at least two of the following properties: a specific gravity of less than or equal to about 1.3, measured at 23° C. according to ASTM D792-08; an Izod notched impact strength of at least about 50 joules per meter, measured at 23° C. according to ASTM D256-10; a heat deflection temperature of at least about 160° C., measured under a stress of 1.82 megapascals according to ASTM D648-07; a 60° gloss of at least about 85, measured according to ASTM D523-08 on an article molded at a mold temperature of 80° C.; and a melt flow index of at least about 5 grams per 10 minutes, measured at 300° C. under a 5 kilogram load according to ASTM D1238-10, Procedure B.

### Embodiment 19

The injection molded article of any of embodiments 1-18, wherein the injection molded article is an automotive headlight bezel.

### Embodiment 20

A composition comprising: about 76 to about 94 weight percent of a poly(arylene ether); about 2 to about 8 weight percent of a rubber-modified polystyrene comprising about 1 to about 30 weight percent, based on the weight of the rubber-modified polystyrene, of rubber particles having a volume average particle diameter of about 0.1 to about 2.0 micrometers; about 2 to about 8 weight percent of hydrogenated block copolymer of an alkenyl aromatic compound and a conjugated diene, wherein the hydrogenated block copolymer has a poly(alkenyl aromatic) content of about 10 to about 45 weight percent, based on the weight of the hydrogenated block copolymer, and wherein the hydrogenated block copolymer has a weight average molecular weight of at least about 200,000 atomic mass units; and about 2 to about 8 weight percent of a hydrocarbon resin; wherein all weight percents are based on the total weight of the composition unless a different weight basis is specified.

### Embodiment 21

The composition of embodiment 20, wherein the poly(arylene ether) is poly(2,6-dimethyl-1,4-phenylene ether) having an intrinsic viscosity of about 0.20 to about 0.60 deciliters per gram, measured at 25° C. in chloroform.

### Embodiment 22

The composition of embodiment 20 or 21, wherein the rubber-modified polystyrene has a gel content of about 10 to about 40 weight percent, and a mineral oil content of less than about 2 weight percent.

### Embodiment 23

The composition of embodiment 22, wherein the rubber-modified polystyrene comprises about 10 to about 16 weight percent, based on the weight of the rubber-modified polystyrene, of rubber particles having a volume average particle diameter of about 0.4 to about 1 micrometers; and wherein the rubber-modified polystyrene has a gel content of about 20 to about 30 weight percent, and a mineral oil content of less than about 1.5 weight percent.

### Embodiment 24

The composition of any of embodiments 20-23, wherein the hydrogenated block copolymer is a linear block copolymer.

### Embodiment 25

The composition of any of embodiments 20-24, wherein the hydrogenated block copolymer excludes the residue of monomers other than the alkenyl aromatic compound and the conjugated diene.

### Embodiment 26

The composition of any of embodiments 20-25, wherein the alkenyl aromatic compound is styrene and the conjugated diene is butadiene.

### Embodiment 27

The composition of any of embodiments 20-26, wherein the hydrogenated block copolymer comprises a polystyrene-poly(ethylene-butylene)-polystyrene triblock copolymer and less than about 20 weight percent, based on the total weight of the hydrogenated block copolymer, of polystyrene-poly(ethylene-butylene) diblock copolymer.

### Embodiment 28

The composition of embodiment 27, wherein the polystyrene-poly(ethylene-butylene)-polystyrene triblock copolymer is substantially free of polystyrene-poly(ethylene-butylene) diblock copolymer.

### Embodiment 29

The composition of any of embodiments 20-28, wherein the hydrocarbon resin has a softening point of about 80 to about 180° C., measured according to ASTM E-28-99.

### Embodiment 30

The composition of any of embodiments 20-29, further comprising about 0.5 to about 6 weight percent, based on the total weight of the composition, of polystyrene, provided that the total weight of polystyrene and the rubber-modified polystyrene is about 2 to about 8 weight percent, based on the total weight of the composition.

### Embodiment 31

The composition of any of embodiments 20-30, wherein unhydrogenated block copolymers of an alkenyl aromatic compound and a conjugated diene, polyamides, polyesters, EPDM rubbers, thermoplastic polyolefins, and thermoplastic vulcanizates are all absent from the composition.

### Embodiment 32

The composition of any of embodiments 20-31, comprising less than about 1 weight percent of any polymer other than the poly(arylene ether), the rubber-modified polystyrene, the hydrogenated block copolymer, and the hydrocarbon resin.

### Embodiment 33

The composition of any of embodiments 20-32, comprising less than about 1 weight percent of a filler.

### Embodiment 34

The composition of any of embodiments 20-33, further comprising one or more additives selected from the group consisting of stabilizers, mold release agents, processing aids, drip retardants, nucleating agents, UV blockers, dyes, pigments, antioxidants, anti-static agents, mineral oil, metal deactivators, antiblocking agents, nanoclays, and electrically conductive agents.

### Embodiment 35

The composition of any of embodiments 20-29 and 31-34, consisting essentially of the poly(arylene ether), the rubber-modified polystyrene, the hydrogenated block copolymer, the aliphatic hydrocarbon resin, and optionally, about 0.5 to about 5 weight percent collectively, based on the total weight of the composition, of one or more additives selected from the group consisting of fillers, stabilizers, mold release agents, processing aids, drip retardants, nucleating agents, UV blockers, dyes, pigments, antioxidants, anti-static agents, mineral oil, metal deactivators, antiblocking agents, nanoclays, and electrically conductive agents.

### Embodiment 36

The composition of embodiment 20, wherein the thermoplastic composition comprises about 80 to about 90 weight percent of the poly(arylene ether), about 3 to about 6 weight percent of the rubber-modified polystyrene, about 3 to about 6 weight percent of the hydrogenated block copolymer; and about 3 to about 6 weight percent of the hydrocarbon resin; wherein the poly(arylene ether) is poly(2,6-dimethyl-1,4-phenylene ether) having an intrinsic viscosity of about 0.35 to about 0.50 deciliter per gram, measured at 25° C. in chloroform; wherein the rubber-modified polystyrene comprises about 10 to about 16 weight percent, based on the weight of the rubber-modified polystyrene, of rubber particles having a volume average particle diameter of about 0.4 to about 1 micrometers; wherein the hydrogenated block copolymer is a polystyrene-poly(ethylene-butylene)-polystyrene triblock copolymer having a weight average molecular weight of about 240,000 to about 400,000 atomic mass units; and wherein the hydrocarbon resin has a softening point of about 120 to about 130° C., measured according to ASTM E-28.

### Embodiment 37

The composition of any of embodiments 36, wherein the composition exhibits at least two of the following properties: a specific gravity of less than or equal to about 1.3, measured at 23° C. according to ASTM D792-08; an Izod notched impact strength of at least about 50 joules per meter, measured at 23° C. according to ASTM D256-10; a heat deflection temperature of at least about 160° C., measured under a stress of 1.82 megapascals according to ASTM D648-07; a 60° gloss of at least about 85, measured according to ASTM D523-08 on an article molded at a mold temperature of 80° C.; and a melt flow index of at least about 5 grams per 10 minutes, measured at 300° C. under a 5 kilogram load according to ASTM D1238-10, Procedure B.

The invention is further illustrated by the following non-limiting examples.

### Examples 1-2, and Comparative Examples 1-11

Individual components used to prepare the compositions in the working examples are summarized in Table 1.

TABLE 1

| Component | Description |
|---|---|
| PPE 0.3 IV | Poly(2,6-dimethyl-1,4-phenylene ether), CAS Reg. No. 25134-01-4, |
| | having an intrinsic viscosity of 0.3 deciliter per gram measured in |
| | chloroform at 25° C. |
| PPE 0.4 IV | Poly(2,6-dimethyl-1,4-phenylene ether), CAS Reg. No. 25134-01-4, |
| | having an intrinsic viscosity of 0.4 deciliter per gram measured in |
| | chloroform at 25° C. |
| PPE 0.46 IV | Poly(2,6-dimethyl-1,4-phenylene ether), CAS Reg. No. 25134-01-4, |
| | having an intrinsic viscosity of 0.46 deciliter per gram measured in |
| | chloroform at 25° C. |
| PS MFI 22 | Atactic polystyrene having a melt flow index of 22 grams per 10 |
| | minutes and a mineral oil content of 4 weight percent. |
| PS MFI 2.4 | Atactic polystyrene having a melt flow index of 2.4 grams per 10 |
| | minutes and no mineral oil. |
| PS MFI 8 | Atactic polystyrene having a melt flow index of 8 grams per 10 |
| | minutes and a mineral oil content of less than 2 weight percent. |
| HIPS | High impact polystyrene having a volume average particle diameter of |
| | 0.6 micrometers, a rubber content of 13.0 weight percent, a gel |
| | content of 12.9 weight percent, a mineral oil content of 1.0 weight |
| | percent, available from Toyo Styrene K.K. as TOYO XL1. |
| HC | Hydrocarbon resin, CAS Reg. No. 123465-34-9, available from |
| | Arakawa Chemical as ARKON P-125. |
| SEBS High MW | Polystyrene-poly(ethylene-butylene)-polystyrene triblock copolymer, |
| | CAS Reg. No. 66070-58-4, having a polystyrene content of 30.0-33.0 |
| | weight percent and a weight average molecular weight of about |
| | 240,000-301,000, available from Kraton Polymers Ltd. as KRATON |
| | G1651. |
| SEBS Low MW | Polystyrene-poly(ethylene-butylene)-polystyrene triblock copolymer, |
| | CAS Reg. No. 66070-58-4, having a polystyrene content of 28.8-31.6 |
| | weight percent and a weight average molecular weight of about |
| | 117,000, available from Kraton Polymers Ltd. as KRATON G1650. |
| Polyoctenylene | Polyoctenylene, CAS Reg. No. 25267-51-0, having a density of 0.91 |
| | grams per cubic centimeter and a MVR of 18 cubic centimeters per 10 |
| | minutes. at 190° C./2.16 kilograms, available from EVONIK as |
| | VESTENAMER 8012. |
| PE | Polyethylene, CAS Reg. No. 9002-88-4, having a density of 0.91 |
| | grams per cubic centimeter and a MVR of 25 cubic centimeters per 10 |
| | minutes at 190° C./2.16 kilograms, available from Nippon Unicar as |
| | NUC POLYETHYLENE DNDJ0405. |
| PETS | Pentaerythritol tetrastearate, CAS Reg. No. 115-83-3. |
| Phosphite 168 | Tris(2,4-di-tert-butylphenyl) phosphite, CAS Reg. No. 31570-04-4. |
| MgO | Magnesium oxide, CAS Reg. No. 1309-48-4, available from Kyowa |
| | Chemical Co. Ltd. as KYOWAMAG 150. |
| ZnS | Zinc sulfide, CAS Reg. No. 1314-98-3, available from Sachtleben |
| | Chemie GmbH as Sachtolith HD. |
| Carbon black | Carbon black, having an iodine number of about 142 milligrams per |
| | gram measured according to ASTM D1510, and a density of 352 |
| | kilograms per cubic meter measured according to ASTM D1513, |
| | available from Cabot Corporation as VULCAN 9A32. |
| TiO₂ | Titanium dioxide, CAS Reg. No. 13463-67-7. |

Compositions are summarized in Table 2, where all component amounts are in parts by weight.

All compositions were prepared on a Toshiba TEM 50 millimeter co-rotating twin-screw extruder operating at 280 rotations per minute and 40 kilograms/hour feed rate. A mild screw design was used to maintain the melt temperature below 635° F. (335° C.). Barrel set temperatures were 240-260-300-300-300-300-300° C. from feed throat to die. After cooling the extrudate through a water bath and pelletizing, physical property test specimens were prepared by injection molding using a target melt temperature of 572° F. (300° C.) and a mold temperature of 176° F. (80° C.). Gloss measurement test specimens were molded under the same conditions, except that mold temperatures of 176° F. (80° C.) or 248° F. (120° C.) were used.

Properties are also summarized in Table 2. Notched Izod impact strength (expressed in joules per meter), was measured at 23° C. according to ASTM D256-10. Tensile strength at yield (expressed in megapascals) and tensile elongation at break (expressed in percent) were measured at 23° C. according to ASTM D638-10. Flexural modulus and flexural strength (both expressed in megapascals) were measured at 23° C. according to ASTM D790-10. Heat deflection temperature (expressed in degrees Centigrade), was measured under a stress of 0.455 or 1.82 megapascals according to ASTM D648-07, using Method B and a sample having dimensions 80 millimeters×10 millimeters×4 millimeters. Melt flow index (expressed in grams per 10 minutes) was measured at 300° C. under a load of 5 kilograms according to ASTM D1238-10, Procedure B. Specific gravity was measured at 23° C. according to ASTM D792-08. Gloss was measured at 60 degrees according to ASTM D523 on an article molded using a mold tool temperature of 80° C. or 120° C.

Examples 1 and 2 in Table 2 include poly(arylene ether), rubber-modified polystyrene, high molecular weight hydrogenated block copolymer, and aliphatic hydrocarbon resin. In both Examples 1 and 2, an excellent balance of specific gravity, impact strength, heat resistance, melt flow, and gloss is achieved.

Comparative Examples 1, 5, 7, and 11, which substitute polystyrene for rubber-modified polystyrene and omit high molecular weight hydrogenated block copolymer and aliphatic hydrocarbon resin, exhibit markedly reduced notched Izod impact strengths compared to Examples 1 and 2.

Comparative Examples 2 and 8, which omit high molecular weight hydrogenated block copolymer and aliphatic hydrocarbon resin, exhibit markedly reduced notched Izod impact strengths compared to Examples 1 and 2.

Comparative Example 3 and 9, which substitute polystyrene for rubber-modified polystyrene and omit aliphatic hydrocarbon resin, exhibit markedly reduced notched Izod impact strength compared to Examples 1 and 2.

Comparative Examples 4 and 10, which omit hydrocarbon resin, exhibit inferior gloss values compared to Examples 1 and 2.

As can be seen from these examples, it is the combination of specific amounts of the poly(arylene ether), the rubber-modified polystyrene, the hydrogenated block copolymer, and the hydrocarbon resin that produces the improved balance of specific gravity and physical properties. Thus, an article injection molded from the composition will not only be lighter than parts molded from conventional injection molding compositions but will also meet performance standards for automotive parts.

TABLE 2

| | C. Ex. 1 | C. Ex. 2 | C. Ex. 3 | C. Ex. 4 | C. Ex. 5 | Ex. 1 |
|---|---|---|---|---|---|---|
| COMPOSITIONS | | | | | | |
| PPE 0.3 IV | 88.7 | 88.7 | 84.7 | 84.7 | 0 | 0 |
| PPE 0.4 IV | 0 | 0 | 0 | 0 | 90 | 84.7 |
| PPE 0.46 IV | 0 | 0 | 0 | 0 | 0 | 0 |
| PS MFI 22 | 0 | 0 | 0 | 0 | 0 | 0 |
| PS MFI 2.4 | 0 | 0 | 0 | 0 | 10 | 0 |
| PS MFI 8 | 10 | 0 | 10 | 0 | 0 | 0 |
| HIPS | 0 | 10 | 0 | 10 | 0 | 5 |
| HC | 0 | 0 | 0 | 0 | 0 | 5 |
| SEBS, High MW | 0 | 0 | 4 | 4 | 0 | 4 |
| SEBS, Low MW | 0 | 0 | 0 | 0 | 0 | 0 |
| Polyoctenylene | 0 | 0 | 0 | 0 | 0 | 0 |
| PE | 0 | 0 | 0 | 0 | 0 | 0 |
| PETS | 0.7 | 0.7 | 0.7 | 0.7 | 0 | 0.7 |
| Phosphite 168 | 0.3 | 0.3 | 0.3 | 0.3 | 0.3 | 0.3 |
| MgO | 0.15 | 0.15 | 0.15 | 0.15 | 0 | 0.15 |
| ZnS | 0.15 | 0.15 | 0.15 | 0.15 | 0 | 0.15 |
| Carbon Black | 0.5 | 0.5 | 0.5 | 0.5 | 0.2 | 0.5 |
| TiO₂ | 0 | 0 | 0 | 0 | 0 | 0 |
| Total | 100.5 | 100.0 | 100.0 | 100.0 | 100.3 | 100.0 |
| PROPERTIES | | | | | | |
| Izod notched | 25 | 37 | 45 | 104 | 23 | 105 |
| impact (J/m) | | | | | | |
| Tensile strength, | 83 | 80 | 78 | 73 | 84 | 73 |
| yield (MPa) | | | | | | |
| Tensile elongation | 12 | 17 | 15 | 17 | 16 | 17 |
| at break (%) | | | | | | |
| Flexural strength | 120 | 115 | 111 | 105 | 120 | 105 |
| (MPa) | | | | | | |
| Flexural Modulus | 2696 | 2594 | 2533 | 2410 | 2663 | 2415 |
| (MPa) | | | | | | |
| HDT at 0.455 | 182 | 182 | 179 | 182 | 184 | 180 |
| MPa (° C.) | | | | | | |
| HDT at 1.82 MPa | 169 | 169 | 166 | 168 | 174 | 166 |
| (° C.) | | | | | | |
| MFI at 300° C., 5 kg | 8.1 | 7.2 | 8.2 | 5.6 | 8.6 | 7.8 |
| (g/10 min) | | | | | | |
| Specific gravity | 1.08 | 1.07 | 1.07 | 1.07 | 1.07 | 1.06 |
| (g/cm³) | | | | | | |
| 60° Gloss, mold tool at | 95 | 92 | 92 | 84 | — | 94 |
| 80° C. | | | | | | |
| 60° Gloss, mold tool at | — | — | — | — | 100 | — |
| 120° C. | | | | | | |
| | C. Ex. 7 | C. Ex. 8 | C. Ex. 9 | C. Ex. 10 | C. Ex. 11 | Ex. 2 |
| COMPOSITIONS | | | | | | |
| PPE 0.3 IV | 0 | 0 | 0 | 0 | 90 | 0 |
| PPE 0.4 IV | 0 | | | | | |
| PPE 0.46 IV | 88.7 | 88.7 | 84.7 | 84.7 | 0 | 84.7 |
| PS MFI 22 | 0 | 0 | 0 | 0 | 10 | 0 |
| PS MFI 2.4 | 0 | 0 | 0 | 0 | 0 | 0 |
| PS MFI 8 | 10 | 0 | 10 | 0 | 0 | 0 |
| HIPS | 0 | 10 | 0 | 10 | 0 | 5 |
| HC | 0 | 0 | 0 | 0 | 0 | 5 |
| SEBS, High MW | 0 | 0 | 4 | 4 | 0 | 4 |
| SEBS, Low MW | 0 | 0 | 0 | 0 | 0 | 0 |
| Polyoctenylene | 0 | 0 | 0 | 0 | 0 | 0 |
| PE | 0 | 0 | 0 | 0 | 0 | 0 |
| PETS | 0.7 | 0.7 | 0.7 | 0.7 | 0 | 0.7 |
| Phosphite 168 | 0.3 | 0.3 | 0.3 | 0.3 | 0 | 0.3 |
| MgO | 0.15 | 0.15 | 0.15 | 0.15 | 0 | 0.15 |
| ZnS | 0.15 | 0.15 | 0.15 | 0.15 | 0 | 0.15 |
| Carbon Black | 0.5 | 0.5 | 0.5 | 0.5 | 0 | 0.5 |
| TiO₂ | 0 | 0 | 0 | 0 | 0 | 0 |
| Total | 100.0 | 100.0 | 100.0 | 100.0 | 100.0 | 100.0 |
| PROPERTIES | | | | | | |
| Izod notched | 26 | 42 | 40 | 91 | 9.2 | 77 |
| impact (J/m) | | | | | | |
| Tensile strength, yield | 84 | 80 | 78 | 75 | 72 | 75 |
| (MPa) | | | | | | |
| Tensile elongation | 28 | 26 | 18 | 19 | 5 | 15 |
| at break (%) | | | | | | |
| Flexural strength | 121 | 117 | 112 | 106 | 114 | 107 |
| (MPa) | | | | | | |
| Flexural Modulus | 2687 | 2610 | 2562 | 2451 | 2639 | 2440 |
| (MPa) | | | | | | |
| HDT at 0.455 MPa | 181 | 181 | 179 | 180 | 187 | 181 |
| (° C.) | | | | | | |
| HDT at 1.82 MPa | 169 | 169 | 165 | 166 | 175 | 167 |
| (° C.) | | | | | | |
| MFI at 300° C., 5 kg | 5.3 | 4.3 | 5.3 | 4.4 | 26.1 | 5.3 |
| (g/10 min) | | | | | | |
| Specific gravity | 1.08 | 1.07 | 1.07 | 1.07 | 1.07 | 1.06 |
| 60° Gloss, mold | 96 | 77 | 88 | 74 | 112 | 91 |
| temperature 80° C. | | | | | | |
| 60° Gloss, mold | — | — | — | — | — | — |
| temperature | | | | | | |
| 120° C. | | | | | | |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. An injection molded article comprising a composition comprising:
about 76 to about 94 weight percent of a poly(arylene ether);
about 2 to about 8 weight percent of a rubber-modified polystyrene comprising about 1 to about 30 weight percent, based on the weight of the rubber-modified polystyrene, of rubber particles having a volume average particle diameter of about 0.1 to about 2.0 micrometers;
about 2 to about 8 weight percent of a hydrogenated block copolymer of an alkenyl aromatic compound and a conjugated diene, wherein the hydrogenated block copolymer has a poly(alkenyl aromatic) content of about 10 to about 45 weight percent, based on the weight of the hydrogenated block copolymer, and wherein the hydrogenated block copolymer has a weight average molecular weight of at least about 200,000 atomic mass units; and
about 2 to about 8 weight percent of a hydrocarbon resin;
wherein all weight percents are based on the total weight of the composition unless a different weight basis is specified.

2. The injection molded article of claim 1, wherein the poly(arylene ether) is poly(2,6-dimethyl-1,4-phenylene ether) having an intrinsic viscosity of about 0.20 to about 0.60 deciliters per gram, measured at 25° C. in chloroform.

3. The injection molded article of claim 1, wherein the rubber-modified polystyrene has a gel content of about 10 to about 40 weight percent, and a mineral oil content of less than about 2 weight percent.

4. The injection molded article of claim 3, wherein the rubber-modified polystyrene comprises about 10 to about 16 weight percent, based on the weight of the rubber-modified polystyrene, of rubber particles having a volume average particle diameter of about 0.4 to about 1 micrometers; and wherein the rubber-modified polystyrene has a gel content of about 20 to about 30 weight percent, and a mineral oil content of less than about 1.5 weight percent.

5. The injection molded article of claim 1, wherein the hydrogenated block copolymer is a linear block copolymer.

6. The injection molded article of claim 1, wherein the hydrogenated block copolymer excludes the residue of monomers other than the alkenyl aromatic compound and the conjugated diene.

7. The injection molded article of claim 1, wherein the alkenyl aromatic compound is styrene and the conjugated diene is butadiene.

8. The injection molded article of claim 1, wherein the hydrogenated block copolymer comprises a polystyrene-poly(ethylene-butylene)-polystyrene triblock copolymer and less than about 20 weight percent, based on the total weight of the hydrogenated block copolymer, of polystyrene-poly(ethylene-butylene) diblock copolymer.

9. The injection molded article of claim 8, wherein the polystyrene-poly(ethylene-butylene)-polystyrene triblock copolymer is substantially free of polystyrene-poly(ethylene-butylene) diblock copolymer.

10. The injection molded article of claim 1, wherein the hydrocarbon resin has a softening point of about 80 to about 180° C., measured according to ASTM E28-99.

11. The injection molded article of claim 1, wherein the composition further comprises about 0.5 to about 6 weight percent polystyrene, provided that the total weight of polystyrene and the rubber-modified polystyrene is about 2 to about 8 weight percent, based on the total weight of the composition.

12. The injection molded article of claim 1, wherein the composition further comprises about 0.5 to about 5 weight percent collectively, based on the total weight of the composition, of one or more additives selected from the group consisting of stabilizers, mold release agents, processing aids, drip retardants, nucleating agents, UV blockers, dyes, pigments, antioxidants, anti-static agents, mineral oil, metal deactivators, antiblocking agents, nanoclays, and electrically conductive agents.

13. The injection molded article of claim 1, wherein unhydrogenated block copolymers of an alkenyl aromatic compound and a conjugated diene, polyamides, polyesters, EPDM rubbers, thermoplastic polyolefins, and thermoplastic vulcanizates are all absent from the composition.

14. The injection molded article of claim 1, wherein the composition comprises less than about 1 weight percent of any polymer other than the poly(arylene ether), the rubber-modified polystyrene, the hydrogenated block copolymer, and the hydrocarbon resin.

15. The injection molded article of claim 1, wherein the composition comprises less than about 1 weight percent of a filler.

16. The injection molded article of claim 1, wherein the composition consists essentially of the poly(arylene ether), the rubber-modified polystyrene, the hydrogenated block copolymer, the aliphatic hydrocarbon resin, and optionally, about 0.5 to about 5 weight percent collectively, based on the total weight of the composition, of one or more additives selected from the group consisting of fillers, stabilizers, mold release agents, processing aids, drip retardants, nucleating agents, UV blockers, dyes, pigments, antioxidants, anti-static agents, mineral oil, metal deactivators, antiblocking agents, nanoclays, and electrically conductive agents.

17. The injection molded article of claim 1, wherein the composition comprises
about 80 to about 90 weight percent of the poly(arylene ether);
about 3 to about 6 weight percent of the rubber-modified polystyrene;
about 3 to about 6 weight percent of the hydrogenated block copolymer; and
about 3 to about 6 weight percent of the hydrocarbon resin;
wherein the poly(arylene ether) is poly(2,6-dimethyl-1,4-phenylene ether) having an intrinsic viscosity of about 0.35 to about 0.50 deciliter per gram, measured at 25° C. in chloroform;
wherein the rubber-modified polystyrene comprises about 10 to about 16 weight percent, based on the weight of the rubber-modified polystyrene, of rubber particles having a volume average particle diameter of about 0.4 to about 1 micrometers;
wherein the rubber-modified polystyrene has a gel content of about 10 to about 16 weight percent, and a mineral oil content of less than about 1.5 weight percent;
wherein the hydrogenated block copolymer is a polystyrene-poly(ethylene-butylene)-polystyrene triblock copolymer having a weight average molecular weight of about 240,000 to about 400,000 atomic mass units; and
wherein the hydrocarbon resin has a softening point of about 120 to about 130° C., measured according to ASTM E28-99.

18. The injection molded article of claim 17, wherein the composition exhibits at least two of the following properties:
a specific gravity of less than or equal to about 1.3, measured at 23° C. according to ASTM D792-08;
an Izod notched impact strength of at least about 50 joules per meter, measured at 23° C. according to ASTM D256-10;
a heat deflection temperature of at least about 160° C., measured under a stress of 1.82 megapascals according to ASTM D648-07;
a 60° gloss of at least about 85, measured according to ASTM D523-08 on an article molded at a mold temperature of 80° C.; and
a melt flow index of at least about 5 grams per 10 minutes, measured at 300° C. under a 5 kilogram load according to ASTM D1238-10, Procedure B.

19. The injection molded article of claim 1, wherein the injection molded article is an automotive headlight bezel.

20. A composition comprising:
about 76 to about 94 weight percent of a poly(arylene ether);
about 2 to about 8 weight percent of a rubber-modified polystyrene comprising about 1 to about 30 weight percent, based on the weight of the rubber-modified polystyrene, of rubber particles having a volume average particle diameter of about 0.1 to about 2.0 micrometers;
about 2 to about 8 weight percent of hydrogenated block copolymer of an alkenyl aromatic compound and a conjugated diene, wherein the hydrogenated block copolymer has a poly(alkenyl aromatic) content of about 10 to about 45 weight percent, based on the weight of the hydrogenated block copolymer, and wherein the hydrogenated block copolymer has a weight average molecular weight of at least about 200,000 atomic mass units; and
about 2 to about 8 weight percent of a hydrocarbon resin;
wherein all weight percents are based on the total weight of the composition unless a different weight basis is specified.

21. The composition of claim 20, wherein the poly(arylene ether) is poly(2,6-dimethyl-1,4-phenylene ether) having an intrinsic viscosity of about 0.20 to about 0.60 deciliters per gram, measured at 25° C. in chloroform.

22. The composition of claim 20, wherein the rubber-modified polystyrene has a gel content of about 10 to about 40 weight percent, and a mineral oil content of less than about 2 weight percent.

23. The composition of claim 22, wherein the rubber-modified polystyrene comprises about 10 to about 16 weight percent, based on the weight of the rubber-modified polystyrene, of rubber particles having a volume average particle diameter of about 0.4 to about 1 micrometers; and wherein the rubber-modified polystyrene has a gel content of about 20 to about 30 weight percent, and a mineral oil content of less than about 1.5 weight percent.

24. The composition of claim 20, wherein the hydrogenated block copolymer is a linear block copolymer.

25. The composition of claim 20, wherein the hydrogenated block copolymer excludes the residue of monomers other than the alkenyl aromatic compound and the conjugated diene.

26. The composition of claim 20, wherein the alkenyl aromatic compound is styrene and the conjugated diene is butadiene.

27. The composition of claim 20, wherein the hydrogenated block copolymer comprises a polystyrene-poly(ethylene-butylene)-polystyrene triblock copolymer and less than about 20 weight percent, based on the total weight of the hydrogenated block copolymer, of polystyrene-poly(ethylene-butylene) diblock copolymer.

28. The composition of claim 27, wherein the polystyrene-poly(ethylene-butylene)-polystyrene triblock copolymer is substantially free of polystyrene-poly(ethylene-butylene) diblock copolymer.

29. The composition of claim 20, wherein the hydrocarbon resin has a softening point of about 80 to about 180° C., measured according to ASTM E-28-99.

30. The composition of claim 20, further comprising about 0.5 to about 6 weight percent, based on the total weight of the composition, of polystyrene, provided that the total weight of polystyrene and the rubber-modified polystyrene is about 2 to about 8 weight percent, based on the total weight of the composition.

31. The composition of claim 20, wherein unhydrogenated block copolymers of an alkenyl aromatic compound and a conjugated diene, polyamides, polyesters, EPDM rubbers, thermoplastic polyolefins, and thermoplastic vulcanizates are all absent from the composition.

32. The composition of claim 20, comprising less than about 1 weight percent of any polymer other than the poly(arylene ether), the rubber-modified polystyrene, the hydrogenated block copolymer, and the hydrocarbon resin.

33. The composition of claim 20, comprising less than about 1 weight percent of a filler.

34. The composition of claim 20, further comprising one or more additives selected from the group consisting of stabilizers, mold release agents, processing aids, drip retardants, nucleating agents, UV blockers, dyes, pigments, antioxidants, anti-static agents, mineral oil, metal deactivators, antiblocking agents, nanoclays, and electrically conductive agents.

35. The composition of claim 20, consisting essentially of the poly(arylene ether), the rubber-modified polystyrene, the hydrogenated block copolymer, the aliphatic hydrocarbon resin, and optionally, about 0.5 to about 5 weight percent collectively, based on the total weight of the composition, of one or more additives selected from the group consisting of fillers, stabilizers, mold release agents, processing aids, drip retardants, nucleating agents, UV blockers, dyes, pigments, antioxidants, anti-static agents, mineral oil, metal deactivators, antiblocking agents, nanoclays, and electrically conductive agents.

36. The composition of claim 20,
wherein the thermoplastic composition comprises
about 80 to about 90 weight percent of the poly(arylene ether);
about 3 to about 6 weight percent of the rubber-modified polystyrene;
about 3 to about 6 weight percent of the hydrogenated block copolymer; and
about 3 to about 6 weight percent of the hydrocarbon resin;
wherein the poly(arylene ether) is poly(2,6-dimethyl-1,4-phenylene ether) having an intrinsic viscosity of about 0.35 to about 0.50 deciliter per gram, measured at 25° C. in chloroform;
wherein the rubber-modified polystyrene comprises about 10 to about 16 weight percent, based on the weight of the rubber-modified polystyrene, of rubber particles having a volume average particle diameter of about 0.4 to about 1 micrometers;
wherein the hydrogenated block copolymer is a polystyrene-poly(ethylene-butylene)-polystyrene triblock copolymer having a weight average molecular weight of about 240,000 to about 400,000 atomic mass units; and
wherein the hydrocarbon resin has a softening point of about 120 to about 130° C., measured according to ASTM E-28.

37. The composition of claim 36, wherein the composition exhibits at least two of the following properties:
a specific gravity of less than or equal to about 1.3, measured at 23° C. according to ASTM D792-08;
an Izod notched impact strength of at least about 50 joules per meter, measured at 23° C. according to ASTM D256-10;
a heat deflection temperature of at least about 160° C., measured under a stress of 1.82 megapascals according to ASTM D648-07;
a 60° gloss of at least about 85, measured according to ASTM D523-08 on an article molded at a mold temperature of 80° C.; and
a melt flow index of at least about 5 grams per 10 minutes, measured at 300° C. under a 5 kilogram load according to ASTM D1238-10, Procedure B.
